(19) United States
(12) Patent Application Publication
(10) Pub. No.: US 2006/0194172 A1
(43) Pub. Date: Aug. 31, 2006

(54) Dental compositions having a phosphorescent material and methods of use

(76) Inventor: Dan Loveridge, Sandy, UT (US)

Correspondence Address: Rick D. Nydegger;WORKMAN NYDEGGER, 1000 Eagle Gate Tower, 60 East South Temple, Salt Lake City, UT, 84111, US

(21) Appl. No.: 11/065,744

(22) Filed: Feb. 25, 2005

(51) Int. Cl. A61C 5/00; C09K 3/00

(52) U.S. Cl. 433/215; 433/228.1; 433/9; 106/35

(57) ABSTRACT

A dental composition can include at least one polymerizable resin and at least one phosphorescent material. Alternatively, a two-part composition can include at least one dental composition configured for placement onto a person's tooth, and at least one composition comprised of a phosphorescent material for combining with the at least one dental composition. The dental composition can be formulated to blend with a person's tooth, and also be capable of phosphorescing. The composition can be used in a method for performing a dental procedure by applying the dental composition to a tooth, and irradiating the dental composition with a light source. Accordingly, the phosphorescence can aid a dental professional in distinguishing between the location of the dental composition and the tooth.

### CROSS-REFERENCE TO RELATED APPLICATIONS

This United States Patent Application cross-references two other United States Patent Applications filed simultaneously herewith on Feb. 25, 2005, entitled, respectively, DENTAL COMPOSITIONS HAVING DUAL DENTAL DIAGNOSTIC CAPABILITIES AND METHODS OF USE with Dan Loveridge, Peter M. Allred and Neil T. Jessop as inventors, attorney Docket No. 7678.913, Express Mail Label No. EV462385885US; and DENTAL COMPOSITIONS HAVING ANTI-STOKES UP CONVERTERS AND METHODS OF USE with Dan Loveridge as inventor, attorney Docket No. 7678.917, Express Mail Label No. EV462385868US, which applications are incorporated herein in their entirety.

### BACKGROUND OF THE INVENTION

1. The Field of the Invention

The present invention relates to dental compositions that include a phosphorescent material. More particularly, the present invention relates to combining phosphorescent materials into sealants, varnishes, restoratives, adhesives, bonding agents, cements, composites, veneers, and crowns for use in dental diagnostic applications.

2. The Relevant Technology

Teeth are important anatomical features that can be seen during normal daily activities. When people smile or converse with each other, their teeth are usually exposed and observable. While the colors, shapes, and arrangement of a person's teeth may not have been important in the past, aesthetically pleasing teeth are becoming more desirable and almost mandatory in developed societies. In part, advances in dentistry and the availability of dental cosmetics has provided people with the ability to have their imperfect teeth reshaped, colored, and/or restored to near perfection.

Dental professionals have used a variety of dental compositions to fix teeth defects such as cavities or broken teeth. Originally, fillings, crowns, and other dental restorative compositions had colors that contrasted or did not blend with a patient's tooth or surrounding teeth. Recently, patients have begun to demand dental compositions that blend with the color of their teeth to produce a more natural visual effect. This demand may have partially been a result of the stigmatism associated with discolored teeth, and the social benefits of having an aesthetically pleasing smile.

In response, various dental compositions have been produced that blend with the color of a patient's teeth. These dental compositions can vary in color so that they can be matched to different colors and shades of teeth. Also, some compositions have been designed to be applied to the teeth in order to provide or enhance a natural white smile. These teeth-blending compositions are aesthetically pleasing because they can blend with existing teeth or make the teeth appear more perfect.

While patients have had favorable responses to teeth-blending dental compositions, it has been difficult for some dental professionals to work with these compositions. A negative consequence arising from the teeth-blending compositions has resulted in dental professionals not being able to adequately distinguish the dental composition from the underlying tooth. As such, an attempt to remove or modify the dental composition may result in damaging the tooth because portions of the tooth may accidentally be removed. While dental compositions that blend with teeth can provide short-term aesthetic benefits, the long-term consequences can include damaging the teeth when the composition has to be removed, repaired, or replaced.

Therefore, what is needed is an improved dental composition that can be formulated to visually blend with the tooth and surrounding teeth, and which can temporarily change colors in response to a specific stimulus.

### BRIEF SUMMARY OF EMBODIMENTS OF THE INVENTION

Generally, a dental composition in accordance with an embodiment of the present invention can be formulated to blend with a person's tooth, and also be capable of phosphorescing. Accordingly, the dental composition can include at least one polymerizable resin and at least one phosphorescent material. As such, the polymerizable resin and phosphorescent material can be admixed into a dental composition that is configured for placement on a person's tooth. The dental composition is formulated to visually blend with the person's tooth under white light (e.g., natural or artificial) and to be capable of phosphorescing after being exposed to certain wavelengths of light (e.g., UV-light).

In another embodiment of the present invention, a two-part composition for use in making a phosphorescent dental composition can be provided. Such a two-part composition can include at least one dental composition configured for placement onto a person's tooth, and at least one composition comprised of a phosphorescent material. The phosphorescent composition can be combined with the at least one dental composition prior to being applied to the person's tooth. The combination can be configured so that it blends with the person's tooth under white light, and phosphoresces after being exposed to certain wavelengths of light.

A method of performing a dental procedure is also in accordance with an embodiment of the present invention. The method includes applying a dental composition to a tooth, where the dental composition contains at least one polymerizable resin and at least one phosphorescent material. Additionally, the method includes irradiating the dental composition with a light source until the composition has absorbed enough energy so that the phosphorescent materials are in an excited state and capable of phosphorescing or begins to phosphoresce. Accordingly, the phosphorescence can aid the dental professional in distinguishing between the location of the dental composition and the tooth because teeth do not naturally phosphoresce.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a side view of a tooth with a cavity that is filled with a phosphorescent filling;

FIG. 1B is a top view of the tooth in FIG. 1A;

FIG. 2A is a side view of a tooth with a cavity that is filled with a phosphorescent filling;

FIG. 2B is a top view of the tooth in FIG. 2A;

FIG. 3A is a top view of a tooth with a pit and fissure;

FIG. 3B is a top view of the tooth in FIG. 3A with the pit and fissure restored with a phosphorescent sealant;

FIG. 4A is a side view of an embodiment of a dental procedure where a crown is being placed onto a tooth with a phosphorescent prosthetic adhesive;

FIG. 4B is a side view of an embodiment of a dental procedure where a crown is affixed to a tooth;

FIGS. 5A and 5B are side views of an orthodontic bracket adhered to a tooth with a phosphorescent bracket adhesive; and

FIGS. 6A and 6B are side views of a tooth having a phosphorescent dental restorative composition.

### DETAILED DESCRIPTION OF EMBODIMENTS OF THE INVENTION

Generally, embodiments of the present invention include dental compositions, two-part dental compositions, and associated methods of making or using the compositions. The terminology employed herein is used for the purpose of describing particular embodiments only and is not intended to be limiting.

As used herein, the term “color changing” refers to a substance or composition that changes color, becomes luminescent, or changes to a contrasting shade when exposed to a certain stimulus or condition, and returns to the original color after the stimulus is removed. Examples of color changing substances include, without limitation, phosphorescent, fluorescent, photochromic, and thermochromic materials.

As used herein, the term “phosphorescent” or “phosphor” refers to any substance containing electrons which temporarily enter an excited state upon exposure to a source of energy, such as light, electricity, or heat, and emit photons of visible light as they return to an unexcited state thereby creating a luminescence that is still visible after the source of energy has been removed. As such, phosphorescent materials can glow in the dark.

As used herein, the term “fluorescent” refers to any substance that becomes luminescent when exposed to light. A fluorescent material can appear to slightly change color or emit color more brightly while being exposed to UV-light or white light, and cease to be luminescent when the light is removed.

As used herein, the term “photochromic” refers to any substance that can change colors or become a contrasting shade when exposed to light. For example, a photochromic substance can originally appear to be clear or white, but darken to a grey color when irradiated with light. A photochromic substance will return to the original color after it is no longer being irradiated with light.

As used herein, the term “thermochromic” refers to any substance that can change color in response to heating or cooling. For example, a thermochromic substance may appear to have an original color or no color under a normal temperature, but change to emit a different color when either heated or cooled. A thermochromic substance will return to the original color after it returns to the normal temperature.

As used herein, the term “dispersement” or “dispersing” refers to placing and distributing phosphorescent materials within a composition.

As used herein, the term “dispersing agent” refers to any substance that prevents phosphorescent materials (particles) from agglomerating or otherwise settling out of the composition.

As used herein, the term “effective amount” refers to at least the minimal amount of a substance or agent, which is sufficient to achieve a desired effect. For example, an effective amount of a phosphorescent material would include the minimum amount that provides the desired phosphorescence.

As used herein, the term “white light” refers to broad spectrum light that can XZO range from IR-light to UV-light. For example, the light emitted from the sun and regular light bulbs can be considered white light.

As used herein, the term “normal conditions” refers to the ordinary conditions of temperature and light that exist in a mouth when it is open or closed in routine daily activities that commonly occur. For example, the opening and closing of a mouth during a conversation or a smile can be characteristic of “normal conditions.”

It should be recognized that the chemical nomenclature employed herein is used for convenience and brevity, and any of the elements recited additionally includes the monovalent or multivalent ions thereof. For example, europium (Eu) includes the element and the monovalent, divalent, trivalent, and other multivalent europium ions, if the valence is possible.

Concentrations, amounts, particles sizes and other numerical data may be presented in a range format. It is to be understood that such a range format is used merely for convenience and brevity and should be interpreted flexibly to include not only the numerical values explicitly recited as the limits of the ranges, but also to include all the individual numerical values or sub-ranges encompassed within that range as if each numerical value and sub-range is explicitly recited. For example, the particle diameter range of about 0.5 micrometers to about 50 micrometers should be interpreted to include not only the explicitly recited limits of about 0.5 micrometers and about 50 micrometers, but also to include such individual diameters such as 1, 2, 10, and 20 micrometers as well as sub-ranges between these individual diameters. This interpretation should apply regardless of the breadth of the range or the characteristic being described, and should apply to ranges having both upper and lower numerical values as well as open-ended ranges reciting only one numerical value.

Dental compositions in accordance with embodiments of the present invention can include sealers, permanent fillings, temporary fillings, cements, varnishes, composites, adhesives, and the like. Accordingly, these dental compositions can be configured for being cured after being placed into the mouth such as for filling and sealing root canals. For example, the dental compositions can be formulated for adhering veneers, inlays, onlays, crowns, pontics, and bridges in the mouth. Also, the dental compositions can be used in orthodontics for affixing an orthodontic bracket to a tooth.

Generally, a dental composition can include at least one polymerizable resin and at least one phosphorescent material that are admixed together into a dental composition that is configured for placement on a person's tooth. The dental composition is formulated to blend with the person's tooth under natural conditions and/or white light. Additionally, the phosphorescent material causes the dental composition to be capable of phosphorescing after being exposed to light.

In another embodiment of the present invention, a kit or two-part composition having a combination of compositions can be provided. Such a combination-of compositions can include at least one dental composition configured for placement onto a person's tooth, and at least one composition comprised of a phosphorescent material. The phosphorescent composition can be used for being combined with the at least one dental composition prior to being applied to the person's tooth. The-combination of compositions can be formulated to blend with the person's tooth under normal conditions and/or white light. Additionally, the combination of compositions can be capable of phosphorescing after being exposed to light.

A dental composition can include any composition that is formulated to be combined with another composition prior to being fixedly applied to a tooth. As such, the resultant combination of compositions, such as an admixture, can be properly formulated to adhere to a tooth, where the individual compositions may or may not have sufficient dental-compatibility or adherence.

Additionally, the dental composition can include solid prefabricated dental prostheses. Accordingly, a dental prosthesis such as a veneer, crown, inlay, onlay, pontic, or bridge can be prefabricated before being adhered to the patient's tooth. These dental prostheses can be comprised of a dental composite that has been cast into a solid form. A dental prosthesis can be affixed to a tooth with an adherent dental composition such as a phosphorescent dental composition. Alternatively, the dental prosthesis can include a phosphorescent material.

A phosphorescent dental composition can be formulated to look natural under normal conditions and/or white light, and phosphoresce in the absence of light or under low intensity white light. Without being bound to theory, it is thought that phosphorescent compositions can be formulated to have these characteristics because the intensity of phosphorescent light is typically weak. Accordingly, when the phosphorescent material is being exposed to light the electrons are being excited into higher energy electron orbitals. After the white light is removed or decreased in intensity, the low intensity emissions can be seen as a soft luminescence. Thus, the amount of phosphorescent materials in a dental composition can be varied to change the intensity level of surrounding light at which the phosphorescence can be observed. Alternatively, some phosphorescent materials can appear to be luminescent while being irradiated by UV-light, and still phosphoresce after the UV-light is removed. As such, sometimes dental diagnostics can be performed with a phosphorescent material under UV-light or under low intensity light.

It is noted that a wide variety of phosphorescent materials can be utilized in the present invention. Examples of phosphorescent materials can include sulfides, oxides, metal aluminate oxides, rare earth oxides, and other similar phosphors. For example, a basic phosphorescent material can be comprised of a ZnO phosphor or a ZnS phosphor. Additional examples of basic phosphorescent materials can include calcium sulfates (CaS), calcium strontium sulfates (CaSrS), zinc sulfates (ZnS), zinc cadmium sulfates (ZnCdS), barium zinc sulfides (BaZS), barium zinc cadmium sulfides (BaZCdS), and strontium sulfides (SrS).

Another class of examples of phosphorescent materials that can be included in the invention can be considered long-life phosphors because, under certain conditions, these phosphors exhibit phosphorescence for a longer duration that other phosphors. A long-life phosphor can be a metal aluminate such as an alkaline earth aluminate oxide. These phosphors can have the formula MAl₂O₄, where the M is an alkaline earth metal or mixture of such metals. Examples of these phosphors include strontium aluminate oxide (SrAl₂O₄), calcium aluminate oxide (CaAl₂O₄), barium aluminate oxide (BaAl₂O₄), and mixtures thereof.

These phosphorescent materials can additionally include an activator such as aluminum (Al), silver (Ag), gold (Au), manganese (Mn), bismuth (Bi), gallium (Ga), indium (In), scandium (Sc), terbium (Th), europium (Eu) lanthanum (La), cerium (Ce), praseodymium (Pr), neodymium (Nd), samarium (Sm), gadolinium (Gd), dysprosium (Dy), holmium (Ho), erbium (Er), thulium (Tm), ytterbium (Yb), lutetium (Lu), tin (Sn), or mixtures thereof. When one of these activators, for example europium (Eu), is complexed with a phosphor, any of the other activators can also be complexed to the phosphor as auxiliary activators. Also, oxides of these activators, for example cesium oxide (Ce₂O₃), can act as auxiliary activators for some phosphors. The activators are thought, without being bound to theory, to enter the crystal lattice of the host material to impart some luminescence thereto. Some examples of phosphors complexed with an activator can include CaS:Bi, CaSrS:Bi, ZnS:Cu, ZnCdS:Cu, ZnS:Co, CaSrS:Bi, and ZnCdS:Ag.

While certain phosphorescent materials have been described as examples, the present invention is intended to be limited to these specific phosphorescent materials. As such, all currently known and future discovered phosphorescent materials are intended to be capable of being included in the phosphorescent dental compositions.

The phosphorescent material can be encapsulated in a glass. For example, the phosphorescent material can be combined with SiO₂ under heat so that glass beads, glass microbeads, or bulk class containing the phosphorescent material can be formed. The phosphorescent material can be encapsulated in a glass comprised of, for example, silicon (Si), cerium (Ce), antimony (Sb), tin (Sn), zirconium (Zr), strontium (Sr), barium (Ba), aluminum (Al), zinc (Zn), and the like. When formed, the bulk class containing a phosphor can then be ground or milled to produce phosphorescent glass particles that can be formulated into the dental composition. It is thought, without being bound to theory, that encapsulating the phosphor in a glass can increase the longevity of the phosphorescence, and prevent” the phosphor from leaching out of the dental composition. Additionally, the glass encapsulated phosphors can increase the biocompatibility of the phosphorescent materials and the phosphorescent dental composition.

Similarly, the phosphorescent material can be encapsulated within a polymeric microbead. In one embodiment the microbead can be comprised of hydrophobic monomers that are polymerized into crosslinked and/or non-crosslinked polymers. Examples of suitable hydrophobic polymers can include crosslinked and non-crosslinked polyacrylates such as polymethyl methacrylate, crosslinked and non-crosslinked polyaromatics such as polystyrene and polyvinyltoluene.

The phosphorescent material and/or encapsulated phosphor can also be admixed with a dispersing agent to facilitate the dispersement and retention of the phosphorescent material in the composition. Examples of dispersing agents include polymers and copolymers of styrene sulfonate salts, acrylic and styrene copolymers, sulfonated polyesters, oleoyl methyl taurine, sodium dodecyl sulfate, amine dispersants; methyl stearate, ethyl stearate, methyl hexanoate, methyl heptanoate, methyl octanoate, methyl laurate, methyl oleate, methyl adipate, methyl caprylate, methyl caproate, methyl anthranilate, methyl palmitate, methyl palmitoleate, methyl oxalate, methyl 2-nonanoate, methyl benzoate, 2-methylbenzophenone, methyl benzilate, methylbenzyl acetate, trimethyl borate, methyl caprate, methyl butyrate, methyl decanoate, methyl cyclohexanecarboxylate, methyl dimethoxyacetate, methyl diphenylacetate, methyl heptanoate, methyl linoleate and the like.

When admixed into a composition, the phosphorescent material can be present in an effective amount to provide phosphorescence to the composition after being exposed to light. While increasing the concentration of phosphorescent material in the composition can increase the phosphorescence, overly concentrated phosphorescent materials can exhibit concentration quenching of the phosphorescent intensity. As such, the concentration of the phosphorescent material can vary depending on the other constituents present within the composition. For example, the phosphorescent material can be present at a preferred range of from about 0.0001% to about 15% by weight, more preferred range of from about 0.01% to about 10% by weight, and most preferred range of from about 0.1% to about 5%. However, higher concentrations can be used in some instances.

Additionally, other color changing substances in conjunction with a phosphorescent material can be incorporated into the dental compositions as long as the dental composition blends with the patient's tooth under white light or normal conditions. An additional color changing substance can provide a phosphorescent dental composition with a color changing feature that is observable without having to remove the surrounding light sources. As such, the second color changing substance can provide for alternate dental diagnostic techniques.

These additional color changing substances can be admixed into a dental composition in an amount sufficient for changing color, even if only slightly, when exposed to the stimulus, that induces the color change. When the dental composition is exposed to the stimulus the color changing% substance can then emit a color that is distinguishable from the tooth for use in dental diagnostics. Examples of color changing substances that can be included in a dental composition with a phosphorescent material can include fluorescent materials, thermochromic materials, and photochromic materials.

A wide range of fluorescent materials can be included in a dental composition with a phosphorescent material. Accordingly, the present invention is not intended to be limited to certain types of fluorescent materials, but can include any type of material that can appear to be luminescent after being exposed to UV-light. Some examples of fluorescent materials can include, without limitation, coumarin derivatives, phthalimide derivatives, fluoranthene derivatives, perylene derivatives, xanthene derivatives, thioxanthene derivatives, pyrano-benzopyran-2,5-dione derivatives, pyrano-quinoline-2,5 derivatives, pyrazole quinoxaline derivatives, 2-pyrano-isoquinoline-3,6-dione derivatives, benzimidazo-benz-isoquinoline-7-one derivatives, acridine derivatives, and the like. Additionally, rare earth complexes, such as lanthanide complexes, can be used as fluorescent materials. Also, the fluorescent materials can be encapsulated in glass or microbeads. When used, fluorescent materials can be present, for example, at a preferred range of from about 0.00001% to about 15% by weight, a more preferred range of from about 0.001% to about 10% by weight, and a most preferred range of from about 0.1% to about 5% by weight of the dental composition. However, higher or lower concentrations can be used in some embodiments, which can depend on the type and concentration of other constituents in the composition.

Also, a wide range of photochromic materials can be admixed into a dental composition having a phosphorescent material. As such, any type of photochromic material can be included in the present invention as long as it can be formulated into a dental composition that can blend with teeth under normal conditions, and change colors when irradiated with light. For example, without limitation, photochromic materials can include substances based on cis/trans isomerism of azobenzene compounds or stilbenes, the interconversion or electrocyclic ring-closure/ring-opening reaction of spiropyran systems or spirooxazins, or on the 1,5-electrocyclization of pentadienyl anions, and spiro-indolizine derivatives. Also, the photochromic materials can be encapsulated in glass or microbeads. When used, the photochromic materials can be present, for example, at a preferred range of from about 0.0001% to about 15% by weight, more preferred range of from about 0.01% to about 10% by weight, most preferred range of from about 0.1% to about 5% by weight of the dental composition. However, higher or lower concentrations can be used depending on the type and concentration of other constituents in the composition.

A phosphorescent dental composition can also include various thermochromic materials, where the type of thermochromic material is not limited. As such, any thermochromic material that can be formulated into a dental composition that blends with a patient's teeth under normal oral temperatures can be used so long as the magnitude of the temperature change to effect the color change is not too large. Typically, a thermochromic material includes an electron donor and an electron acceptor pair. Examples of electron donors include substituted phenylmethanes, fluoranes, indolylphthalides, spiropyranes, coumarins, and the like. Examples of electron acceptors include phenols, azoles, organic acids, and esters. The amount and type of the thermochromic material present in the dental composition can be varied depending on the temperature change desired in order to effect the color change.

Additionally, the dental compositions can include a variety of materials such as polymerizable resins, polymerization initiators, fillers, coupling agents, plasticizers and the like. The polymerizable resin can include monomers, oligomers, and polymers having one or more ethylenically unsaturated groups, where ethylenically unsaturated groups can be polymerized by free radial polymerization. Such free radical polymerizable materials include monomers and/or mono-, di- or poly-acrylates and methacrylates. For example, the polymerizable resins can include methyl acrylate, methyl methacrylate, ethyl acrylate, isopropyl methacrylate, n-hexyl acrylate, stearyl acrylate, allyl acrylate, glycerol diacrylate, glycerol triacrylate, ethyleneglycol diacrylate, diethyleneglycol diacrylate, triethyleneglycol dimethacrylate, diurethane dimethacrylate, 1,3-propanediol diacrylate, 1,3-propanediol dimethacrylate, trimethylolpropane triacrylate, 1,2,4-butanetriol trimethacrylate, 1,4-cyclohexanediol diacrylate, pentaerythritol triacrylate, pentaerythritol tetraacrylate, pentaerythritol tetramethacrylate, sorbitol hexacrylate, the diglycidyl methacrylate of bis-phenol (“Bis-GMA”), bis[1-(2-acryloxy)]-p-ethoxyphenyldimethylmethane, bis[1-(3-acryloxy-2-hydroxy)]-p-propoxyphenyldimethylmethane, trishydroxyethyl-isocyanurate trimethacrylate, the bis-acrylates and bis-methacrylates of polyethylene glycols of molecular weight 200-500, copolymerizable mixtures of acrylated monomers, and copolymerizable acrylated oligomers, and the like. Alternatively, phosphoric acid derivatives and carboxylic acid derivatives of these ethylenically unsaturated monomers can be used. Also, vinyl compounds such as styrene, diallyl phthalate, divinyl succinate, divinyl adipate and divinylphthalate can be polymerized. Additionally, mixtures of two or more of these free radically polymerizable materials can be used if desired. However, it should be recognized that this is not an exhaustive listing of polymerizable resins, and other polymerizable resins can be used in accordance with the present invention.

The polymerizable resins can be included in the dental composition over a wide range of concentrations. The concentration can depend on the amount of filler, plasticizer, and polymerization initiator as well as other factors. For example, the dental composition can have a polymerizable resin such as an ethylenically unsaturated monomer at a preferred range of from about 10% to about 99% by weight, more preferred range of from about 15%-80% by weight, and most preferred range of from about 25% to about 50% by weight.

Typically, free radical polymerization requires an initiator to generate a free radical. Various types of initiators can produce a free radical upon being exposed to light, heat, or chemicals. The initiator compounds are provided into the dental compositions of the invention in an effective amount to initiate or enhance the rate of polymerization or curing.

Photo-initiators are a group of compounds that will generate a free radical when exposed to light having a specific wavelength. As such, different photo-initiators can be selected depending on the wavelength of light that will initiate the polymerization. Examples of photo-initiators can include benzophenone, benzoin, 9,10-phenanthrenequinone, diacetyl, furil, anisil, 4,4+-dichlorobenzil, 4,4′-dialkoxybenzil, phenylpropanedione, acylphosphine oxides, camphorquinone, derivatives thereof, and the like. Photopolymerization can be initiated, for example, by irradiation with light having a wavelength of from about 400 nm to about 500 nm.

Heat-initiators can be used in hot-curing systems, which is particularly suitable for producing inlays and onlays. Some heat-initiators can be activated with temperatures less than 150° C. Examples of heat-initiators can include t-butyl peroxide, dibenzoyl peroxide, dilauroyl peroxide, t-butyl peroctoate, t-butyl perbenzoate, and the like.

On the other hand, in certain applications a chemical-initiator, which typically is a system of at least two co-initiators that generate a free radical, can be used to induce polymerization. These chemical-initiator systems use a reactive pair, for example, benzoyl peroxide, lauryol peroxide, or dibenzoyl peroxide, in combination with a N,N-dimethyl-p-toluidine, N,N-dihydroxyethyl-p-toluidine, and other similar amines. Alternatively, a combined system including a photo-initiator, heat-initiator, and/or chemical-initiator can be used.

The concentration of the polymerization initiator depends on the concentration of the polymerizable resin, or more particularly on the concentration of the ethylenically unsaturated monomers. Additionally, the concentration of the polymerization initiator depends on the type of initiator. For example, the dental composition can include a polymerization initiator at a preferred range of from about 0.001% to about 5% by weight, more preferred range of from about 0.01% to about 2.5% by weight, and most preferred range of from about 0.1% to about 1% by weight. However, the concentration of initiator can be varied depending on the type of initiator and/or type of resin as well as the desired properties of the composition.

In another embodiment, a dental composition can include a filler to impart radiopaque, radiolucent, and/or nonradiopaque visual characteristics to the composition. The particles can include organic materials and inorganic materials. Examples of organic fillers include pulverized polycarbonates, polyepoxides, and the like. Additionally, polymeric particles or microbeads comprised of homopolymers or heteropolymers of the already described monomers can be used as organic fillers. Also, mixtures of fillers can be used.

Examples of inorganic fillers are naturally-occurring or synthetic materials such as quartz, nitrides (e.g., silicon nitride), colloid silica, feldspar, borosilicate; kaolin, ytterbium trifluoride, talc, and glasses. The glasses can be comprised of, for example, silicon (Si), cerium (Ce), antimony (Sb), tin (Sn), zirconium (Zr), strontium (Sr), barium lo a h (Ba), aluminum (Al), zinc (Zn), and the like. More particularly, the glasses can be oxides of these materials.

In one embodiment, the composition can include a filler at a preferred range of from about 0% to about 90% by weight, more preferred range of from about 0% to about 50% by weight, and most preferred range of from about 0% to about 25%. The filler can be comprised of particles having a preferred diameter range of from about 0.005 micrometers to about 50 micrometers, more preferred range of from about 0.5 micrometers to about 25 micrometers, or most preferred range of from about 1 micrometer to about 10 micrometers. For alternative embodiments it may be more preferable for the fillers having an average particle size of from about 0.005 micrometers to about 2 micrometers can be used. However, larger or smaller particles sizes can be used. Additionally, x-ray opaque fillers having particles sizes less than 5 micrometers such as ytterbium trifluoride and the like can impart beneficial characteristics to the tooth.

In order to enhance the bond between the filler and the dental composition, a coupling agent can optionally be used. Examples of coupling agents can include, without limitation, gamma-methacryloxypropyltrimethoxysilane, gamma-mercaptopropyltriethoxysilane, beta-(3,4-epoxycyclohexyl)-ethyltrimethoxysilane, gamma-glycidoxypropyltrimethoxysilane, and the like.

Various other additives can be included within the dental composition in accordance with the present invention. These additives can include stabilizers, U absorbers, polymerization accelerants, polymerization inhibitors, dyes, pigments, and lubricants. Additionally, the dental compositions can include flavorants, anti-microbials, fragrance, viscosity modifiers, rheology modifiers, fluoride releasing materials, and plasticizers.

Another embodiment of the present invention provides a method of performing a dental procedure. The method includes applying a dental composition to a tooth, where the dental composition is comprised of at least one polymerizable resin and at least one phosphorescent material. Additionally, the method includes irradiating the dental composition with a light source. The light source can emit any wavelength of light so long as it energizes a phosphorescent material to a level that enables phosphorescence to be emitted from the dental composition after the intensity of the light is sufficiently decreased or the light source is removed. Alternatively, some phosphorescent materials are brightly luminescent while being irradiated with UV-light, which can enable some dental diagnostics with phosphorescent dental compositions under UV-light.

Additionally, the method can be further comprised of decreasing the intensity of the light source so that the phosphorescence being emitted from the dental composition can be visualized. After the intensity of the light source has been decreased, a dental professional can visualize the phosphorescence being emitted from the dental composition. Alternatively, the phosphorescence can be viewed while under i-light. In any event, this can enable the dental professional to distinguish between the tooth and the dental composition applied thereto. As such, the phosphorescence can allow for the dental professional to be able to identify a boundary between the dental composition and the tooth.

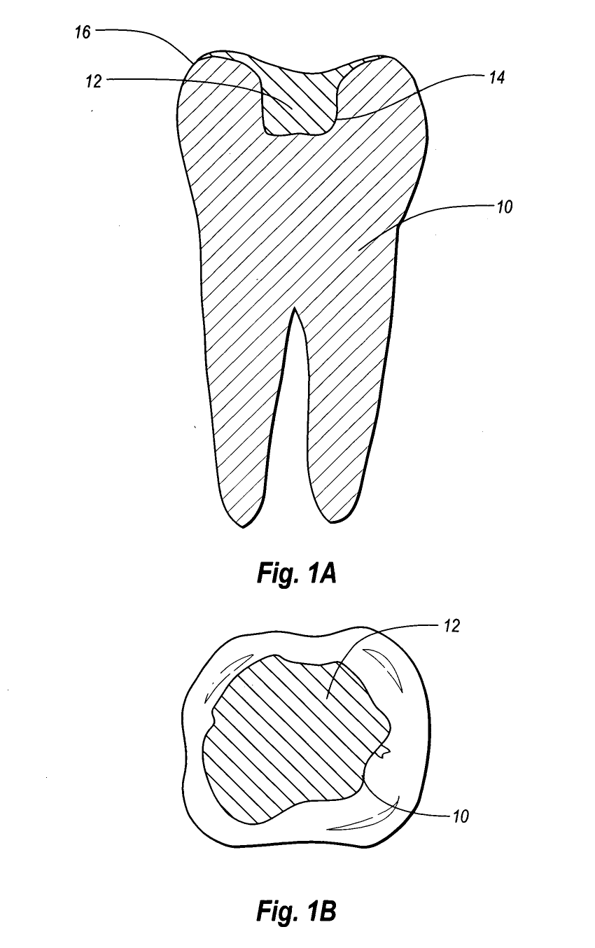

FIGS. 1A and 1B depict an embodiment of the present invention that includes a tooth 10 having a phosphorescing dental composition 12 applied thereto. More particularly, during a dental procedure the tooth 10 has a cavity 14 that has been prepared by a dental professional. As such, the phosphorescing dental composition 12 can be configured into a filling 12 for use in treating the cavity 14. After the cavity 14 has been filled, a light source can then be used to irradiate the filling 12 for a sufficient duration in order to enable phosphorescence. When the light source is decreased in intensity, the filling 12 phosphoresces. In some instances the dental professional may determine that the tooth 10 has superfluous portions 16 of dental material.

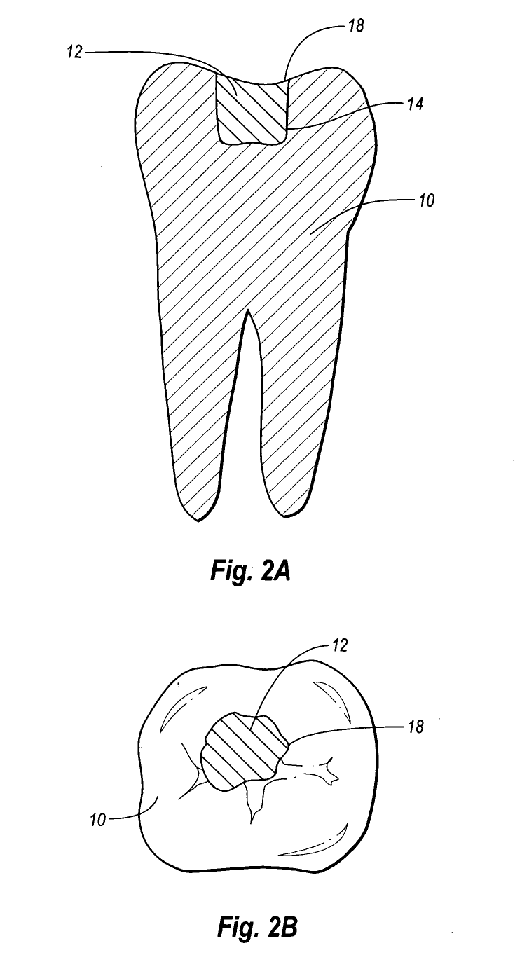

In another embodiment of the present invention depicted in FIGS. 2A and 2B, the dental professional can remove the superfluous portion (as shown in FIGS. 1A and 1B) from the tooth 10 during the dental procedure. Since phosphorescence can be visualized prior to curing, the superfluous portion can be easily removed before polymerization of the resin. Alternatively, the superfluous portion can be removed after the resin has been cured on the tooth 10. This can be done by grinding or other procedures known and practiced by dental professionals. As such, the tooth 10 can be treated so that the filling 12 fills the cavity 14 to conform to typical dental standards. After this is complete, the dental professional can visualize the boundary 18 between the filling 14 and the tooth in order to make sure the treatment is sufficient.

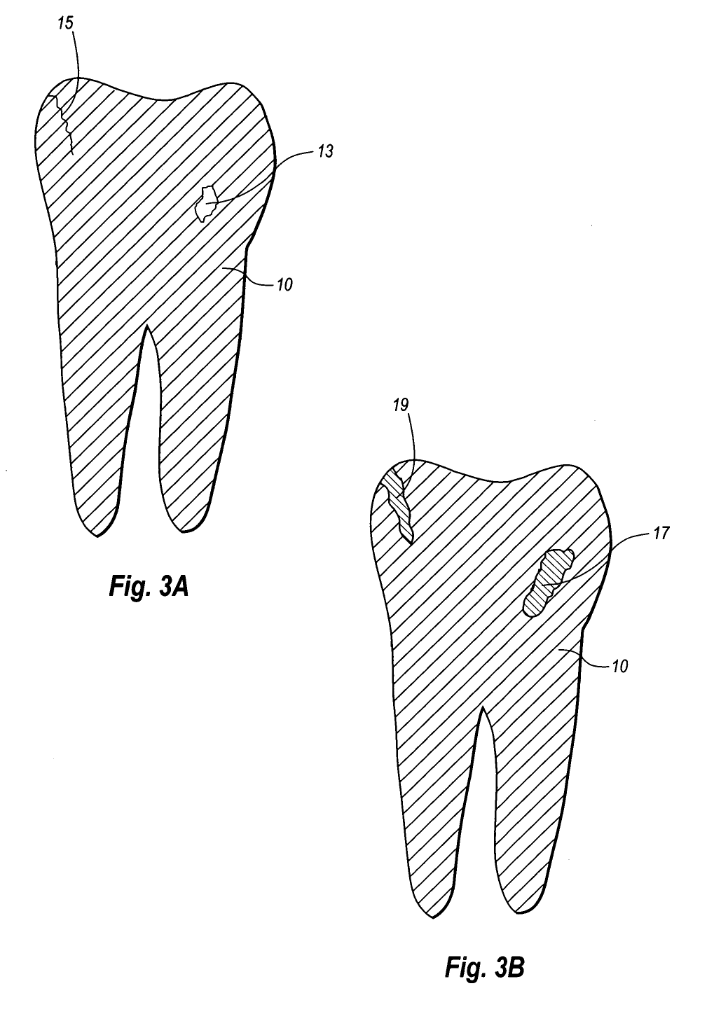

Additionally, FIGS. 3A and 3B depict another embodiment of the present invention that includes repairing a tooth 10 having a pit 13 and fissure 15. During a dental procedure a dental professional can identify the location of a pit 13 or fissure 15 in a tooth 10. Accordingly, the phosphorescing dental composition can be configured into a sealant. The dental professional can apply the pit sealant 17 over the pit 13. Also, the dental professional can apply the fissure sealant 19 to the tooth 10 so as to seal the fissure 15. In any event, the dental professional can irradiate the pit sealant 17 and/or the fissure sealant 19 with UV-light until the dental compositions phosphoresce.

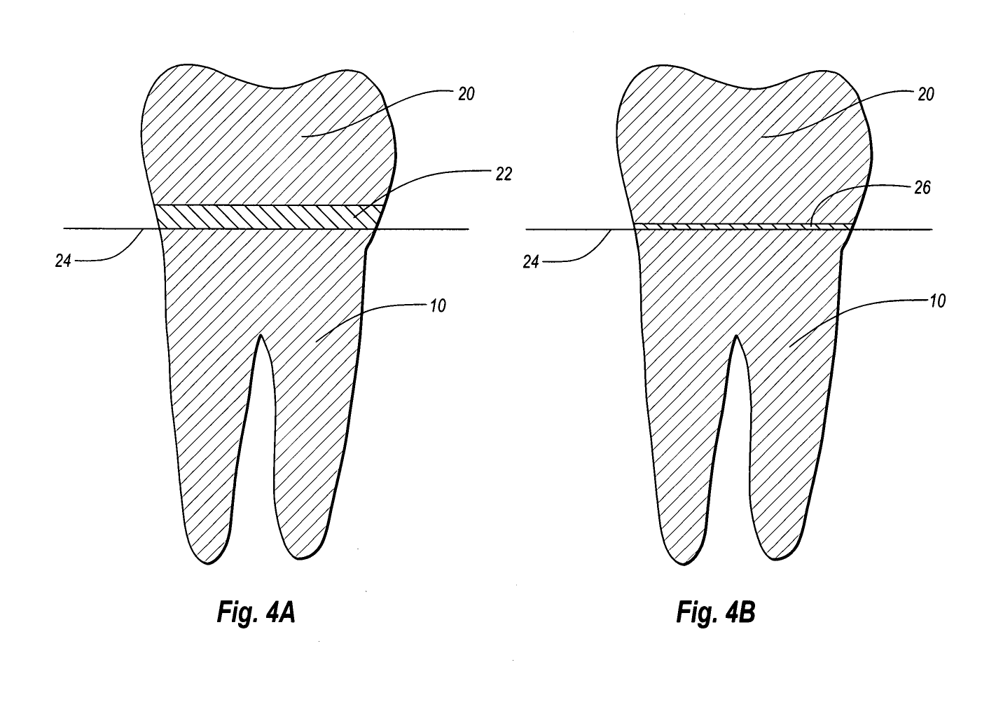

FIGS. 4A and 4B depict another embodiment of the present invention that includes affixing a crown 20 to the tooth 10 during a dental procedure. Accordingly, a dental composition 22 including a polymerizable resin and phosphorescent material are admixed and configured into a prosthetic adhesive 22. The adhesive 22 is applied such that it is between the tooth 10 and the crown 20 when the crown 20 is being positioned onto the tooth 10, as depicted in FIG. 4A. Usually, the crown 20 will be affixed so that it is above or at the gum line 24. Alternatively, other dental prostheses may be used, some of which may be comprised of a phosphorescent material.

After the crown 20 is affixed to the tooth, as depicted in FIG. 4B, a visible boundary 26 may exist. The visible boundary 26 may be observed to distinguish the crown 20 from the tooth 10. In order to better distinguish the crown 20 from the tooth 10, some of the adhesive may be present at the visible boundary 26. As such, the visible boundary 26 may exhibit phosphorescence. Additionally, if any superfluous phosphorescent adhesive is forced out from between the crown 20 and the tooth, it may be removed before or after curing.

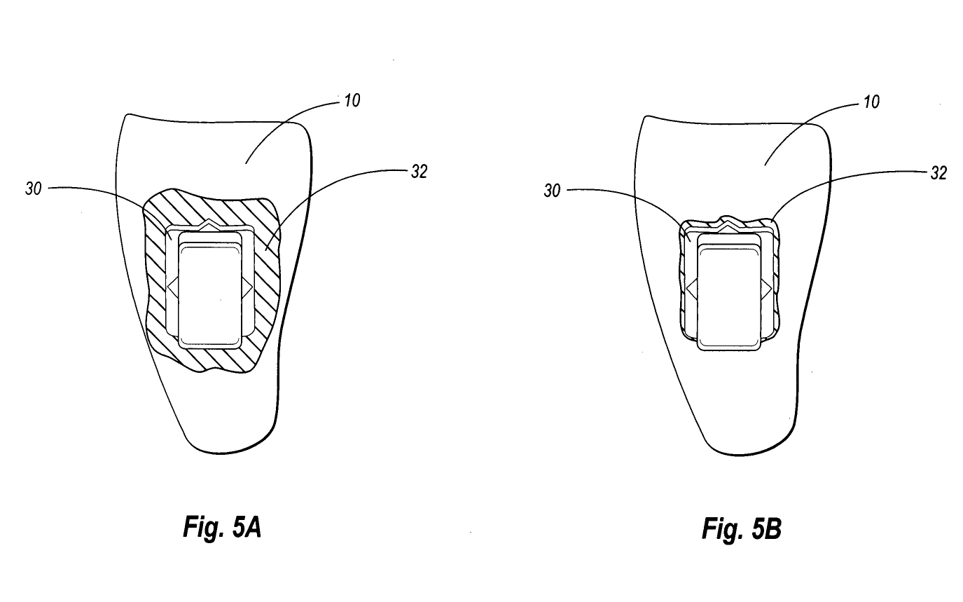

Another embodiment of the present invention includes affixing an orthodontic bracket 30 to a tooth 10, as depicted in FIGS. 5A and 5B. As such, the dental procedure can include applying a phosphorescent bracket adhesive 32 to the tooth 10. Alternatively, the bracket adhesive. 32 can be applied directly to the bracket 30. The bracket 30 is then applied to the tooth 10, and positioned into a correct location. Accordingly, the adhesive 32 can be irradiated with light so that phosphorescence can be observed. The dental professional can then determine if there is any extraneous or superfluous adhesive 32 around the bracket 30, as depicted in FIG. 5A. As depicted in FIG. 5B, any superfluous adhesive 32 can be removed before or after curing.

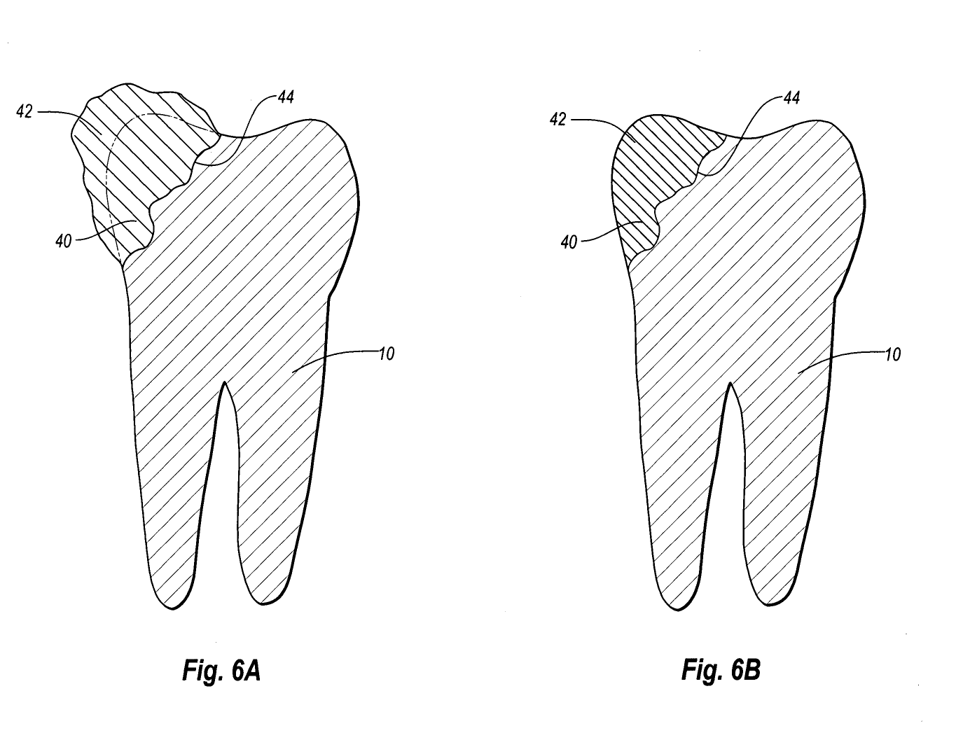

FIGS. 6A and 6B depict another embodiment of the present invention that includes applying a dental restorative composition 40 to the tooth 10. During the dental procedure, a phosphorescent dental restorative composition 40 can be applied to the tooth 10. However, it is possible that too much of the restorative composition 40 can be present on the tooth 10 so that a superfluous portion 42 needs to be removed, as depicted in FIG. 6A. In order to facilitate determining how much needs to be removed, the dental professional can irradiate the restorative composition 40 with light so that it will be capable of phosphorescing. This can also aid in identifying the boundary 46 between the restorative composition 40 and the tooth 10.

Accordingly, it may be determined that a superfluous portion 42 of the restorative composition 40 needs to be removed. As such, the dental procedure can include shaping the restorative composition 40 into a dental restoration 46 as depicted in FIG. 6B. The shaping can be preformed before the restorative composition 40 has been cured. Alternatively, the shaping can be performed after the restorative composition 40 has been cured into a hardened dental restoration 46.

After the dental diagnostic procedure has been completed for any methods of dental procedures that utilize a dental composition including phosphorescent material, the dental professional can terminate the process of irradiating the dental composition with light. As such, the light source can be extinguished so that the dental composition is no longer being exposed to light for a time period long enough so that the phosphorescent materials no longer phosphoresce. Consequently the dental composition can then convert back to blending with the patient's teeth. Thus, the dental composition can reversibly change colors for use in dental diagnostics, and then return to the original teeth-blending color.

Subsequent to any of the procedures described, a dental professional may need to distinguish between a phosphorescent dental composition and the tooth after the composition has been in place for some time. Accordingly, the dental professional can irradiate the phosphorescent dental composition with light. After the intensity of the light is decreased so that phosphorescence can be visualized, or while irradiated with UV-light, the boundary between the phosphorescent dental composition and the tooth can be determined. For example, if the dental restorative depicted in FIG. 6B needs to be removed and/or replaced, phosphorescence can be used to enable the dental professional to remove the dental restorative without removing too much of the tooth. Thus, the removal can be performed until the tooth does not exhibit any phosphorescence.

In another embodiment of the present invention, a dental procedure can be performed with a dental composition having a phosphorescent material and another color changing substance. The additional color changing substance can be used to enhance a dental professional's ability to perform dental diagnostics by providing at least one alternative stimulus that can change the color of the dental composition. As such, the dental composition will be able to change color while being exposed to light, and phosphoresce in the absence of light.

For example, a dental composition having a phosphorescent material and a fluorescent material can be applied to a patient's tooth. As such, the dental composition can fluoresce while being exposed to UV-light so that the dental restoration can be distinguished from the tooth. Accordingly, the dental composition will have fluorescent and phosphorescent color changing dental diagnostic capabilities.

In another example, a dental composition having a phosphorescent material and a photochromic material can be applied to a patient's tooth. When the dental composition is irradiated with light, the dental restorative will change color, where the intensity and duration of the irradiation required to effect the color change can depend on the concentration and type of photochromic material. Thus, the dental composition can enable a dental professional to be capable of performing photochromic and phosphorescent dental diagnostics.

Additionally, a dental composition having a phosphorescent material and a thermochromic material can be applied to a patient's tooth. The resulting dental composition will be blend with a person's teeth under normal oral temperatures, but will change color when either heated or cooled so as to be distinguishable from the tooth. As such, this type of composition will have two paths for use in dental diagnostics by being thermochromic as well as phosphorescent under different conditions.

The present invention is further exemplified in the following examples, which are offered by way of illustration and are not intended to limit the invention in any manner.

### EXAMPLE 1

A light-curable filling material containing a phosphorescent material is prepared in accordance with the present invention. The dispersment of a ZnS:Cu complex at 2% by weight of the filling composition into 22% by weight Bis-GMA is facilitated by adding 0.1% by weight sodium dodecyl sulfate to the composition. The mixture is then processed with 50% by weight barium silicate glass powder, 5% by weight barium fluorosilicate glass powder, 5% by weight pyrogenic silica, and 15% by weight ytterbium trifluoride to produce a homogeneous composite. Additionally, 0.7% by weight camphorquinone, 0.1% by weight hydroquinone monoethyl ether, and 0.1% by weight ethyl-4-dimethylaminobenzoate are admixed into the homogeneous composite.

The homogeneous mixture is applied to an artificial tooth as a filling, and cured by 4 minutes of irradiation with light at a wavelength of 400-500 nm. The filling material is exposed to white light for 30 seconds, and then the light is extinguished. It is expected that the filling material will display green phosphorescence, where a boundary will be observable between the filling material and the artificial tooth.

### EXAMPLE 2

A light-curable orthodontic bracket adhesive containing a phosphorescent material is prepared in accordance with the present invention. A CaS:Bi complex at 1% by weight of the adhesive composition is dispersed into 88% by weight Bis-GMA. The mixture is then processed with 10% by weight silanized barium glass powder. Additionally, 0.6% by weight camphorquinone, 0.2% by weight hydroquinone monoethyl ether, and 0.2% by weight ethyl-4-dimethylaminobenzoate are admixed into the composition to form a bracket adhesive.

The bracket adhesive is applied to an artificial tooth, and cured by irradiation with light at a wavelength of 470 nm for 3 minutes. The cured bracket adhesive is exposed to white light for 1 minute before the light is removed. It is expected that the bracket adhesive will display violet phosphorescence, where a boundary will be observable between the adhesive and the artificial tooth.

### EXAMPLE 3

A light-curable dental sealant containing a phosphorescent material is prepared in accordance with the present invention. A CaSrS:Bi complex at 3% by weight of the composition is admixed into 60% by weight Bis-GMA and 36% by weight triethylene glycol dimethacryate. Additionally, 0.4% by weight camphorquinone, 0.2% by weight hydroquinone monoethyl ether, and 0.5% by weight ethyl-4-dimethylaminobenzoate are admixed with the composition to form a dental sealant.

The dental sealant is applied to an artificial tooth, and cured by irradiation with light at a wavelength of 400-500 nm for 3 minutes. The cured dental sealant is exposed to white light for 45 seconds before reducing the intensity of the light. It is expected that the dental sealant will display blue phosphorescence, where a boundary will be observable between the dental sealant and the artificial tooth.

The present invention may be embodied in other specific forms without departing from its spirit or essential characteristics. The described embodiments and examples are to be considered in all respects only as illustrative and not restrictive. The scope of the invention is, therefore, indicated by the appended claims rather than by the foregoing description. All derivatives: which come within the meaning and range of equivalency of the claims are to be embraced within their scope.

What is claimed is:

1. A dental composition that blends with a color of a person's tooth, and is capable of phosphorescing after being adhered to a person's tooth, the dental composition comprising:
at least one polymerizable resin in a dental composition configured for placement on a person's tooth; and
at least one phosphorescent material admixed into the dental composition, wherein the dental composition is capable of blending with the person's tooth and the at least one phosphorescent material causes the dental composition to be capable of phosphorescing after being exposed to light.

2. A dental composition in accordance with claim 1, further comprising a free radical polymerization initiator selected from the group consisting of a photo-initiator, heat-initiator, chemical-initiator, and combinations thereof.

3. A dental composition in accordance with claim 1, further comprising a filling material.

4. A dental composition in accordance with claim 1, further comprising at least one color changing substance selected from the group consisting of a fluorescent material, a photochromic material, and a thermochromic material.

5. A dental composition in accordance with claim 1, wherein the at least one phosphorescent material is comprised of a phosphor selected from the group consisting of an calcium sulfides, calcium strontium sulfides, zinc sulfides, zinc cadmium sulfides, barium zinc sulfides, barium zinc cadmium sulfides, strontium sulfides, strontium aluminate oxides, calcium aluminate oxides, barium aluminate oxides, and combinations thereof.

6. A dental composition in accordance with claim 6, wherein the at least one phosphorescent material includes at least one activator selected from the group consisting of Al, Ag, Au, Mn, Bi, Ga, In, Sc, Ce, Th, Eu, La, Nd, Sm, Gd, Dy, Ho, Er, Tm, Yb, Lu, Sn, Pr, and combinations thereof.

7. A dental composition in accordance with claim 1, wherein the at least one phosphorescent material is encapsulated in a glass or microbead.

8. A two-part composition for use in making a phosphorescent dental composition, the two-part composition comprising:
at least one dental composition configured for placement onto a person's tooth; and
at least one phosphorescent material for combining with the at least one dental composition, wherein the at least one dental composition combined with the at least one phosphorescent material is capable of blending with the person's tooth, and capable of phosphorescing after being exposed to light.

9. A two-part composition in accordance with claim 8, wherein the at least one dental composition includes a polynierizable resin.

10. A two-part composition in accordance with claim 8, wherein the at least one dental composition fuirther comprises a free radical polymerization initiator selected from the group consisting of a photo-initiator, heat-initiator, chemical-initiator, and combinations thereof.

11. A two-part composition in accordance with claim 8, further comprising a filling material.

12. A two-part composition in accordance with claim 8, wherein the at least one phosphorescent material is comprised of a phosphor selected from the group consisting of an calcium sulfides, calcium strontium sulfides, zinc sulfides, zinc cadmium sulfides, barium zinc sulfides, barium zinc cadmium sulfides, strontium sulfides, strontium aluminate oxides, calcium aluminate oxides, barium aluminate oxides, and combinations thereof.

13. A two-part composition .mn accordance with claim 12, wherein the at least one phosphorescent material includes an activator selected from the group consisting of Al, Ag, Au, Mn, Bi, Ga, In, Sc, Ce, Th, Eu,. La, Nd, Sm, Gd, Dy, Ho, Er, Tm. Yb, Lu, Sn, Pr, and combinations thereof.

14. A two-part composition in accordance with claim 9, wherein the at least one phosphorescent material is encapsulated in a glass or a microbead.

15. A two-part composition in accordance with claim 9, wherein the at least one dental composition or the at least one phosphorescent material is formulated into a form selected from the group consisting of a powder, liquid, suspension, dispersion, emulsion, paste, gel, cream, and solid.

16. A two-part composition in accordance with claim 9, further comprising z:) O ok * at least one color changing material for combining with the at least one dental composition, the at least one color changing material being selected from the group consisting of a fluorescent material, a photochromic material, and a thermochromic material.

17. A method of performing a dental procedure, the method comprising:
applying a dental composition to a tooth, the dental composition being comprised of at least one polymerizable resin and at least one phosphorescent material; and
irradiating the dental composition with a light source, the light source being one of a UV-light and a white light.

18. A method in accordance with claim 17, further comprising:
decreasing an intensity of the light source so that phosphorescence being emitted from the dental composition can be visualized; and
visualizing the phosphorescence being emitted from the dental composition, wherein the visualizing is under one of UV-light and no light.

19. A method in accordance with claim 17, further comprising removing a superfluous portion from the dental composition.

20. A method in accordance with claim 17, further comprising affixing a dental prosthesis to the tooth, wherein the dental prosthesis is selected from the group consisting of a veneer, crown, inlay, onlay, pontic, and bridge.

21. A method in accordance with claim 17, further comprising affixing an orthodontic bracket to the tooth.

22. A method in accordance with claim 17, further comprising shaping the dental composition into a dental restoration.

23. A method in accordance with claim 17, wherein the dental composition includes at least one color changing substance selected from the group consisting of a fluorescent material, and a photochromic material, and the method further comprises stimulating the at least one color changing substance so that the dental composition changes color.
